(19) United States
(12) Patent Application Publication
(10) Pub. No.: US 2026/0296216 A1
(43) Pub. Date: Oct. 1, 2026

(54) MOVING OBJECT

(71) Applicant: HONDA MOTOR CO., LTD., Tokyo (JP)

(72) Inventors: Yu SANOGAWA, Tokyo (JP); Yohei NIWA, Tokyo (JP)

(73) Assignee: HONDA MOTOR CO., LTD., Tokyo (JP)

(21) Appl. No.: 19/575,639

(22) Filed: Mar. 23, 2026

(30) Foreign Application Priority Data
Mar. 26, 2025 (JP) 2025-051638

(51) Int. Cl. B60L 15/20; B60L 7/10

(52) U.S. Cl. CPC B60L 15/2036; B60L 15/2009; B60L 7/10; B60L 2240/14; B60L 2240/465; B60L 2250/28

(57) ABSTRACT

A moving object includes: a first drive source; a second drive source; and a control. The control device is configured to, in response to a slip occurring at at least one of a left outputter and a right outputter while the first drive source and the second drive source drive the right outputter and the left outputter, perform dual outputter driving force reduction control such that driving force to be outputted to an outputter at which a relatively large slip has occurred is reduced to reduce the slip, and driving force to be outputted to an outputter at which a relatively small slip has occurred or no slip has occurred is reduced to the same value as the driving force of the outputter at which the relatively large slip has occurred.

This application is based upon and claims the benefit of priority from prior Japanese patent application No. 2025-051638, filed on March 26, 2025, the entire contents of which are incorporated herein by reference.

### TECHNICAL FIELD

The present disclosure relates to a moving object.

### BACKGROUND ART

In recent years, as a specific countermeasure against global climate change, efforts toward realization of a low-carbon society or a decarbonized society are activated. A reduction in CO₂ emission amount and an improvement in energy efficiency are also required for vehicles such as automobiles, and research and development have been conducted on electrification techniques for battery electric vehicles and hybrid electrical vehicles, for example.

JP2903821B discloses a technique in which, when a brake control request remains 2-channel control during traveling on a high μ road, brake pressures are independently controlled for the left and right drive wheels in response to occurrence of an acceleration slip, and when the brake control request remains 1-channel control during traveling on a low μ road, traveling on a split μ road, or the like, the same TCS brake control is performed on both the left and right drive wheels based on an average value of acceleration slip conditions of the left and right drive wheels in response to the occurrence of the acceleration slip.

### SUMMARY OF INVENTION

Some moving objects in which left and right output units (for example, wheels) are driven by different drive sources do not include a differential device (so-called differential gear). For such a moving object, there may be room for improvement from the viewpoint of securing straight traveling stability when a slip occurs at at least one of the left and right output units.

Aspects of the present disclosure relate to a moving object capable of securing straight traveling stability of the moving object in a case where a slip occurs at at least one of left and right output units even when the moving object in which the left and right output units are driven by different drive sources does not include a differential device.

According to an aspect of the present disclosure, there is provided a moving object including:

a first drive source configured to output braking force and driving force to one of a left outputter and a right outputter;

a second drive source configured to output braking force and driving force to the other of the left outputter and the right outputter; and

a control device configured to control the first drive source and the second drive source, in which

the control device is configured to, in response to a slip occurring at at least one of the left outputter and the right outputter while the first drive source and the second drive source drive the right outputter and the left outputter, perform dual outputter driving force reduction control such that

driving force to be outputted by one of the first drive source and the second drive source that outputs the driving force to an outputter at which a relatively large slip has occurred is reduced to reduce the slip, and

driving force to be outputted by the other of the first drive source and the second drive source that outputs the driving force to an outputter at which a relatively small slip has occurred or no slip has occurred is reduced to the same value as the driving force of the outputter at which the relatively large slip has occurred.

According to the present disclosure it is possible to provide a moving object capable of securing straight traveling stability of the moving object in a case where a slip occurs in at least one of left and right output units even when the moving object in which the left and right output units are driven by different drive sources does not include a differential device.

### BRIEF DESCRIPTION OF DRAWINGS

Exemplary embodiment(s) of the present invention will be described in detail based on the following figures, wherein

FIG. 1 is a diagram illustrating a schematic configuration of a moving object according to the present embodiment;

FIG. 2 is a block diagram illustrating a functional configuration of a control device mounted on the moving object of the present embodiment;

FIG. 3 is a diagram illustrating an image of an outline of dual output unit driving force reduction control performed by the control device of the present embodiment;

FIG. 4 is a flowchart illustrating an example of the dual output unit driving force reduction control performed by the control device of the present embodiment;

FIG. 5 is a flowchart illustrating a subroutine (Hi_μ wheel determination processing) in the flowchart of FIG. 4;

FIG. 6 is a time chart illustrating behaviors of a torque command value (MOT torque command) for a motor, a drive torque (actual torque) output from the motor, and the like when the control illustrated in the flowchart of FIG. 4 is executed; and

FIG. 7 is a flowchart illustrating another example of the dual output unit driving force reduction control performed by the control device of the present embodiment.

### DESCRIPTION OF EMBODIMENTS

Hereinafter, an embodiment according to the present disclosure will be described in detail below with reference to the drawings. Not all the features to be described in the following embodiments are necessarily essential for the present disclosure. Two or more features among a plurality of features to be described in the following embodiment may be combined as desired. In the following description, the same or similar elements are denoted by the same or similar reference numerals, and a description thereof may be omitted or simplified as appropriate.

First, a vehicle V including a control device (control device 10 to be described later), which is an embodiment of the present disclosure, will be described. The vehicle V of the present embodiment is an example of a moving object in the present disclosure.

### Vehicle

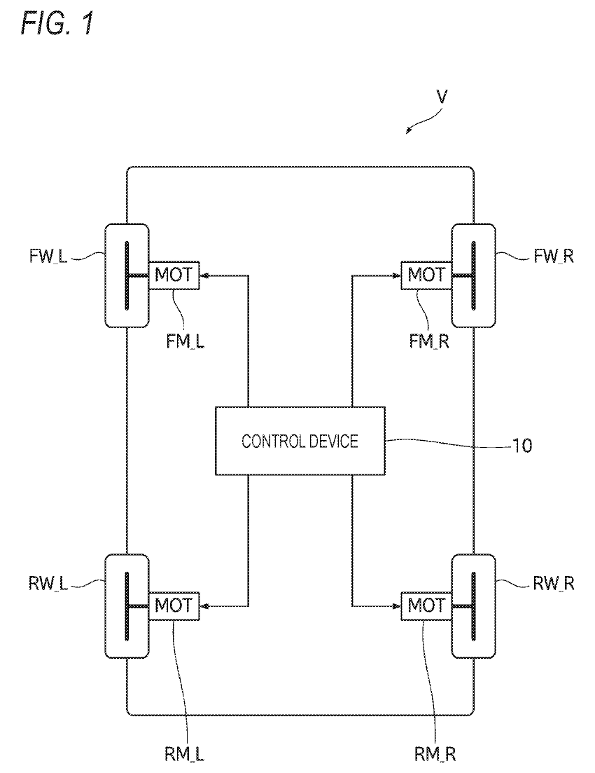

A vehicle V illustrated in FIG. 1 is a battery electric vehicle using an electric motor as a driving force source. In the example illustrated in FIG. 1, the vehicle V includes left and right front wheels FW_L and FW_R as output units that steer the vehicle V, and includes left and right rear wheels RW_L and RW_R as output units that do not steer the vehicle V. The left front wheel FW_L and the right front wheel FW_R can also be referred to as steering wheels in the vehicle V.

The vehicle V includes a motor FM_L as a first drive source that outputs braking force and driving force to the left front wheel FW_L (that is, one output unit that steers the vehicle V), and includes a motor FM_R as a second drive source that outputs braking force and driving force to the right front wheel FW_R (that is, the other output unit that steers the vehicle V).

Further, the vehicle V includes a motor RM_L as a third drive source that outputs braking force and driving force to the left rear wheel RW_L (that is, one output unit that does not steer the vehicle V), and includes a motor RM_R as a fourth drive source that outputs braking force and driving force to the right rear wheel RW_R (that is, the other output unit that does not steer the vehicle V).

The vehicle V further includes a control device 10 that independently controls the motors FM_L, FM_R, RM_L, and RM_R.

Each of the motors FM_L, FM_R, RM_L, and RM_R is a motor-generator mainly used as a drive source of the vehicle V, and is implemented by, for example, an AC motor. Each of the motors FM_L, FM_R, RM_L, and RM_R operates as an electric motor by being supplied with electric power from a battery (not illustrated), and outputs power for the vehicle V to travel.

Further, each of the motors FM_L, FM_R, RM_L, and RM_R can also operate as an electric generator for regeneration during braking of the vehicle V to perform power generation (so-called regenerative power generation). Electric power generated by the regenerative operation of each of the motors FM_L, FM_R, RM_L, and RM_R is supplied to the battery via, for example, a power conversion device (not illustrated) to charge the battery.

The motor FM_L is connected to the left front wheel FW_L, and an output of the motor FM_L is transmitted to the left front wheel FW_L. Therefore, the motor FM_L drives the left front wheel FW_L by performing a power running operation as an electric motor. Further, the motor FM_L brakes the left front wheel FW_L by performing a regenerative operation as an electric generator.

The motor FM_R is connected to the right front wheel FW_R, and an output of the motor FM_R is transmitted to the right front wheel FW_R. Therefore, the motor FM_R drives the right front wheel FW_R by performing a power running operation as an electric motor. Further, the motor FM_R brakes the right front wheel FW_R by performing a regenerative operation as an electric generator.

The motor RM_L is connected to the left rear wheel RW_L, and an output of the motor RM_L is transmitted to the left rear wheel RW_L. Therefore, the motor RM_L drives the left rear wheel RW_L by performing a power running operation as an electric motor. Further, the motor RM_L brakes the left rear wheel RW_L by performing a regenerative operation as an electric generator.

The motor RM_R is connected to the right rear wheel RW_R, and an output of the motor RM_R is transmitted to the right rear wheel RW_R. Therefore, the motor RM_R drives the right rear wheel RW_R by performing a power running operation as an electric motor. Further, the motor RM_R brakes the right rear wheel RW_R by performing a regenerative operation as an electric generator.

In the example illustrated in FIG. 1, the vehicle V is a four-wheel drive battery electric vehicle in which all four wheels of the left and right front wheels FW_L and FW_R and the left and right rear wheels RW_L and RW_R are driven by the motors FM_L, FM_R, RM_L, and RM_R, respectively, but is not limited thereto. For example, the vehicle V may be a front-wheel drive battery electric vehicle in which only the left and right front wheels FW_L and FW_R are driven by the motors FM_L and FM_R, respectively, or a rear-wheel drive battery electric vehicle in which only the left and right rear wheels RW_L and RW_R are driven by the motors RM_L and RM_R, respectively. That is, the present disclosure is also applicable to a battery electric vehicle in which only the left and right front wheels or only the left and right rear wheels are driven by motors.

### Control Device

The control device 10 is a device (computer) for integrally controlling the entire vehicle V, and is implemented by, for example, an electronic control unit (ECU) including a processor (not illustrated) that performs various types of calculation, a memory (not illustrated) that stores various types of information, and an interface (not illustrated) that controls input and output of data between inside and outside of the control device 10. The control device 10 may be implemented by one ECU or may be implemented by a plurality of ECUs.

In the present embodiment, the control device 10 is configured to be able to execute dual output unit driving force reduction control by controlling each of the motors FM_L, FM_R, RM_L, and RM_R.

The dual output unit driving force reduction control is performed, for example, when a slip occurs at at least one of the left front wheel FW_L and the right front wheel FW_R while the motor FM_L and the motor FM_R drive the left front wheel FW_L and the right front wheel FW_R, respectively. In the dual output unit driving force reduction control, control is performed such that, for example, driving force of a motor (motor FM_L or motor FM_R) corresponding to an output unit in which a relatively large slip has occurred among the left and right front wheels FW_L and FW_R is reduced to prevent the slip at the output unit, and driving force of a motor corresponding to an output unit in which a relatively small slip has occurred or no slip has occurred is reduced to the same value as the driving force of the output unit in which a relatively large slip has occurred.

In addition, the control device 10 may perform the dual output unit driving force reduction control when a reduction amount of the driving force of the output unit in which a relatively large slip has occurred among the left and right front wheels FW_L and FW_R is equal to or greater than a predetermined value. For example, it is assumed that the left front wheel FW_L slips and the right front wheel FW_R does not slip. In this case, a main ECU 11 may perform the dual output unit driving force reduction control when a difference between an FL base torque and an FL_MTCS base torque (that is, the reduction amount of the driving force) to be described later is equal to or greater than a predetermined value.

In this way, by performing the dual output unit driving force reduction control when the reduction amount of the driving force of the output unit in which a relatively large slip has occurred is equal to or greater than the predetermined value, it is possible to reduce the driving force of the output unit in which a relatively small slip has occurred or no slip has occurred when the reduction amount of the driving force of the output unit in which a relatively large slip has occurred is equal to or greater than the predetermined value, and thus it is possible to reduce an instance where the driving force of the output unit in which a relatively small slip has occurred or no slip has occurred is reduced while securing straight traveling stability of the vehicle V.

Further, the control device 10 may perform the dual output unit driving force reduction control when an operation amount (for example, an AP opening degree to be described later) of an accelerator pedal as an operator that acquires a braking request and a drive request for the vehicle V is less than a predetermined value. In this way, when the operation amount of the accelerator pedal of the vehicle V is less than the predetermined value, it is possible to reduce the driving force of the output unit in which a relatively small slip has occurred or no slip has occurred, and thus it is possible to reduce an instance where the driving force of the output unit in which a relatively small slip has occurred or no slip has occurred is reduced while securing straight traveling stability of the vehicle V.

When the operation amount of the accelerator pedal is equal to or greater than the predetermined value, the control device 10 may reduce the reduction amount of the driving force of the output unit in which a relatively small slip has occurred or no slip has occurred, as compared with the case where the operation amount of the accelerator pedal is less than the predetermined value. In this way, when the operation amount of the accelerator pedal is equal to or greater than the predetermined value, the reduction amount of the driving force of the output unit in which a relatively small slip has occurred or no slip has occurred is made smaller than that when the operation amount is less than the predetermined value, so that it is possible to secure the straight traveling stability of the vehicle V while controlling the reduction amount of the driving force of the output unit in which a relatively small slip has occurred or no slip has occurred.

When the operation amount of the accelerator pedal is equal to or greater than the predetermined value, the control device 10 may reduce the reduction amount of the driving force of the output unit in which a relatively small slip has occurred or no slip has occurred as the operation amount of the accelerator pedal increases. In this way, when the operation amount of the accelerator pedal is equal to or greater than the predetermined value, the reduction amount of the driving force of the output unit in which a relatively small slip has occurred is reduced as the operation amount increases, so that the reduction amount of the driving force of the output unit in which a relatively small slip has occurred can be appropriately controlled according to the operation amount of the accelerator pedal.

Hereinafter, the control device 10 will be described in more detail. However, it should be noted that the example described here is merely an example, and the present disclosure is not limited thereto.

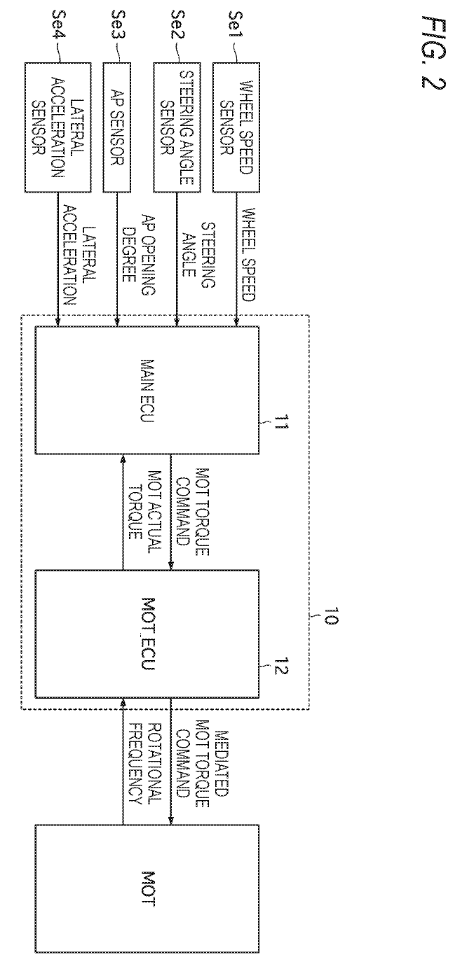

As illustrated in FIG. 2, the control device 10 includes, for example, the main ECU 11 and a motor ECU (illustrated as "MOT_ECU" in FIG. 2) 12.

The main ECU 11 controls each of the motors FM_L, FM_R, RM_L, and RM_R (illustrated as "MOT" in FIG. 2) in cooperation with the motor ECU 12, and performs the dual output unit driving force reduction control.

For example, the main ECU 11 calculates a vehicle speed, a slip rate at each of the wheels FW_L, FW_R, RW_L, and RW_R, and the like based on a wheel speed of each of the wheels FW_L, FW_R, RW_L, and RW_R detected by a wheel speed sensor Se1. Then, the main ECU 11 monitors occurrence of a slip at each of the wheels FW_L, FW_R, RW_L, and RW_R based on the slip rate at each of the wheels FW_L, FW_R, RW_L, and RW_R.

The main ECU 11 derives a base torque of each of the wheels FW_L, FW_R, RW_L, and RW_R based on a steering angle of the vehicle V detected by a steering angle sensor Se2 and an accelerator pedal opening degree (AP opening degree) detected by an AP sensor Se3. Here, the AP opening degree corresponds to an operation amount of the accelerator pedal which is an operator that acquires a braking request and a drive request for the vehicle V. Further, the base torque is a target value of a torque required to output a basic driving force from the output unit (that is, the wheel) when the vehicle V travels.

Hereinafter, the base torque of the left front wheel FW_L is also referred to as an "FL base torque", and the base torque of the right front wheel FW_R is also referred to as an "FR base torque". Hereinafter, the FL base torque and the FR base torque are also collectively referred to as an "FL/FR base torque" or an "FR/FL base torque".

Further, when detecting a slip at each of the wheels FW_L, FW_R, RW_L, and RW_R, the main ECU 11 derives an MTCS base torque of each of the wheels FW_L, FW_R, RW_L, and RW_R based on a target rotational frequency (in other words, a target rotational speed) of each of the wheels FW_L, FW_R, RW_L, and RW_R according to the slip rate and the base torque of each of the wheels FW_L, FW_R, RW_L, and RW_R.

Here, the MTCS base torque is a target value as a base torque when a motor traction control system (MTCS) is operated by controlling an output of a motor that drives a corresponding output unit (that is, a wheel), and is reduced as compared to the base torque at the normal time (that is, when the MTCS is not operated).

For example, the MTCS base torque of the left front wheel FW_L (hereinafter also referred to as the "FL_MTCS base torque") is reduced as compared to the FL base torque, which is the base torque of the left front wheel FW_L at the normal time. Similarly, the MTCS base torque of the right front wheel FW_R (hereinafter, also referred to as the "FR_MTCS base torque") is reduced as compared to the FR base torque, which is the base torque of the right front wheel FW_R at the normal time. Hereinafter, the FL_MTCS base torque and the FR_MTCS base torque are also collectively referred to as the "FL/FR_MTCS base torque" or "FR/FL_MTCS base torque".

When the FL/FR_MTCS base torque is derived, the main ECU 11 derives reduction rates of the left and right front wheels FW_L and FW_R and a difference between the reduction rates of the left and right front wheels FW_L and FW_R based on the FL/FR_MTCS base torque and an actual torque (in other words, an MOT actual torque) of each of the left and right front wheels FW_L and FW_R received from the motor ECU 12.

Hereinafter, an actual torque of the left front wheel FW_L (that is, an actual torque of the motor FM_L) is also referred to as an "FL actual torque", and particularly, the FL actual torque during the MTCS operation is also referred to as an "FL_MTCS torque". A command torque for the motor FM_L is also referred to as an "FL MOT command torque".

Hereinafter, an actual torque of the right front wheel FW_R (that is, an actual torque of the motor FM_R) is also referred to as an "FR actual torque", and particularly, the FR actual torque during the MTCS operation is also referred to as an "FR_MTCS torque". A command torque for the motor FM_R is also referred to as an "FR MOT command torque".

The reduction rate is an evaluation value representing a ratio of the actual torque to the command torque to the corresponding motor. For example, assuming that the reduction rate of the left front wheel FW_L is an FL reduction rate, the FL reduction rate [%] = FL_MTCS torque/FL MOT command torque × 100 [%] can be satisfied. Similarly, assuming that the reduction rate of the right front wheel FW_R is an FR reduction rate, the FR reduction rate [%] = FR_MTCS torque/FR MOT command torque × 100 [%] can be satisfied.

The main ECU 11 adjusts the FL/FR_MTCS base torque based on the difference between the reduction rates of the left and right front wheels FW_L and FW_R and a lateral acceleration of the vehicle V (in other words, a vehicle body) detected by a lateral acceleration sensor Se4, and passes the adjusted torque value (adjusted target MTCS torque to be described later) to the motor ECU 12 as the command torque (MOT torque command). For example, when the FR_MTCS base torque is adjusted, the main ECU 11 may pass the torque value after adjusting the FR_MTCS base torque to the motor ECU 12 as the command torque to the motor FM_L. During the MTCS operation and when the adjustment of the FL/FR_MTCS base torque is unnecessary, the main ECU 11 may pass the FL/FR_MTCS base torque to the motor ECU 12 as the command torque to the motors FM_L and FM_R. When the MTCS is not operated, the main ECU 11 may pass the FL/FR base torque to the motor ECU 12 as the command torque.

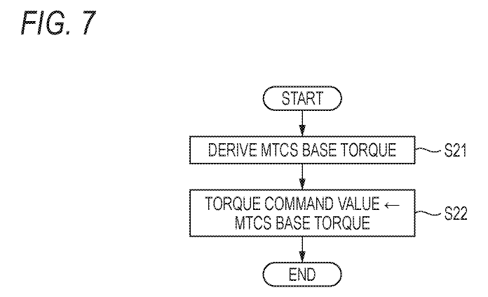

The same applies to the left and right rear wheels RW_L and RW_R. That is, during the MTCS operation, the main ECU 11 may pass the MTCS base torque for the left and right rear wheels RW_L, RW_R to the motor ECU 12 as the command torque of the motors corresponding thereto. In addition, when the MTCS is not operated, the main ECU 11 may pass the base torque for the left and right rear wheels RW_L and RW_R to the motor ECU 12 as the command torque of the motors corresponding thereto. However, in the present embodiment, from the viewpoint of securing the total driving force in the vehicle V, the MTCS base torque for the left and right rear wheels RW_L and RW_R that are non-steering wheels is different from the MTCS base torque for the left and right front wheels FW_L and FW_R that are steering wheels, and the adjustment based on the reduction rate is not performed (for example, see FIG. 7).

The motor ECU 12 controls each of the motors FM_L, FM_R, RM_L, and RM_R based on a command from the main ECU.

For example, the motor ECU 12 acquires a rotational frequency of each of the motors FM_L, FM_R, RM_L, and RM_R (more specifically, a rotational speed that is a rotational frequency per unit time), derives an actual torque of each of the motors FM_L, FM_R, RM_L, and RM_R (that is, the actual torque of each of the wheels FW_L, FW_R, RW_L, and RW_R) based on the rotational frequency, and passes the actual torque to the main ECU 11.

The motor ECU 12 also controls each of the motors FM_L, FM_R, RM_L, and RM_R based on a command torque (MOT torque command) from the main ECU 11. Specifically, the motor ECU 12 mediates the command torque from the main ECU 11 according to the actual torque, and controls each of the motors FM_L, FM_R, RM_L, and RM_R (mediated torque command). For example, in a case where the MOT torque command from the main ECU 11 greatly deviates from the actual torque, when the torque according to the command value is output as it is, a shock occurs in the vehicle V. Therefore, the motor ECU 12 controls the output torque to gradually approach the command torque in consideration of the actual torque according to the mediated torque command as described above.

### Outline of Dual Output Unit Driving Force Reduction Control

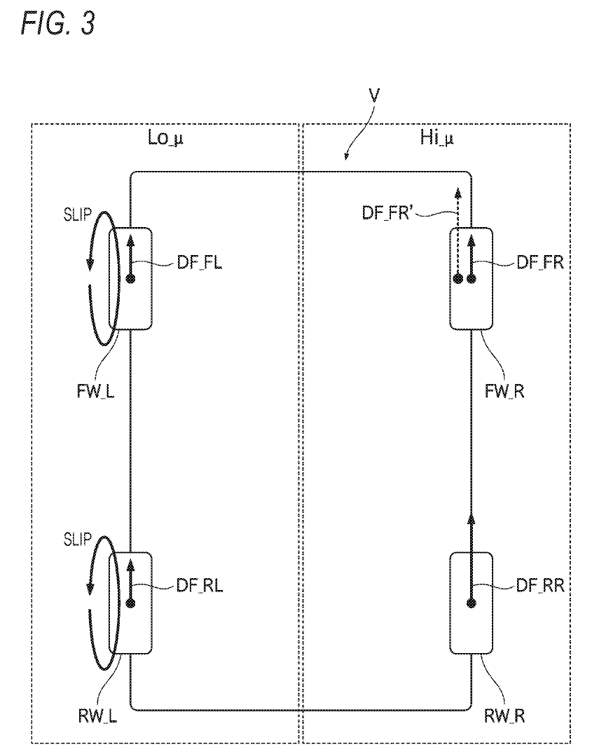

An outline of control (dual output unit driving force reduction control) performed by the control device 10 of the present embodiment will be described with reference to FIG. 3. In the example illustrated in FIG. 3, the output unit on the left side in the vehicle V is an output unit (hereinafter, also referred to as a "Lo_μ wheel") in which a relatively large slip has occurred, and is denoted by "Lo_μ". Therefore, both the left front wheel FW_L and the left rear wheel RW_L are Lo_μ wheels. On the other hand, the output unit on the right side in the vehicle V is an output unit in which a relatively small slip has occurred or no slip has occurred (hereinafter, also referred to as a "Hi_μ wheel"), and is denoted by "Hi_μ". Therefore, both the right front wheel FW_R and the right rear wheel RW_R are Hi_μ wheels.

As illustrated in FIG. 3, for example, when a slip occurs at the left front wheel FW_L, which is a steering wheel, the control device 10 reduces driving force of the motor FM_L (first drive source) that outputs the driving force to the left front wheel FW_L (Lo_μ wheel) in which the slip has occurred to reduce the slip occurring at the left front wheel FW_L. At the same time, the control device 10 reduces driving force DF_FR of the right front wheel FW_R facing the left front wheel FW_L to match driving force DF_FL of the left front wheel FW_L. Driving force DF_FR' indicated by a dotted arrow in FIG. 3 indicates driving force of the right front wheel FW_R when not reduced.

On the other hand, even if the left rear wheel RW_L, which is a non-steering wheel, slips, the control device 10 maintains driving force DF_RR of the right rear wheel RW_R facing the left rear wheel RW_L as it is, unlike the front wheels, which are steering wheels.

As described above, when at least one (left front wheel FW_L in the example illustrated in FIG. 3) of the left front wheel FW_L and the right front wheel FW_R slips while the motor FM_L (first drive source) and the motor FM_R (second drive source) are driving the left front wheel FW_L (one output unit) and the right front wheel FW_R (the other output unit), respectively, the control device 10 reduces the driving force (drive torque) of the motor FM_L that outputs the driving force to the left front wheel FW_L (Lo_μ wheel) in which a relatively large slip has occurred to reduce the slip. At the same time, the control device 10 performs the dual output unit driving force reduction control such that the driving force (drive torque) of the motor FM_R that outputs the driving force to the right front wheel FW_R (Hi_μ wheel) in which no slip has occurred (or a relatively small slip has occurred) is reduced to the same value as the driving force DF_FL of the left front wheel FW_L in which a relatively large slip has occurred.

Therefore, according to the vehicle V equipped with the control device 10, when a slip (for example, a slip caused by acceleration) occurs in at least one of the left and right output units (the left front wheel FW_L or the right front wheel FW_R; the left front wheel FW_L in the example of FIG. 3), the driving force of the output unit (left front wheel FW_L in the example of FIG. 3) in which a slip has occurred is reduced to reduce the slip, and the driving force of the other output unit (the right front wheel FW_R or the left front wheel FW_L; the right front wheel FW_R in the example of FIG. 3) is reduced to the same value as the driving force of the output unit (left front wheel FW_L in the example of FIG. 3) in which a slip has occurred, so that it is possible to prevent the generation of the yaw moment in the vehicle V. Accordingly, even when the vehicle V does not include a differential device (so-called differential gear), it is possible to prevent a yaw behavior of the vehicle V when a slip occurs at at least one of the left and right output units, and secure the straight traveling stability of the vehicle V.

In addition, in the example illustrated in FIGS. 1 and 3, in the vehicle V, the left and right front wheels FW_L and FW_R are one set of left and right output units (that is, steering wheels) that steers the vehicle V, and the left and right rear wheels RW_L and RW_R are the other set of left and right output units (that is, non-steering wheels) that do not steer the vehicle V. The vehicle V includes the motor RM_L and the motor RM_R as drive sources that output braking force and driving force to the left and right rear wheels RW_L and RW_R that do not steer the vehicle V. In such a case, when a slip occurs at at least one of the left and right rear wheels RW_L and RW_R while the motors RM_L and RM_R respectively drive the left and right rear wheels RW_L and RW_R, the control device 10 reduces driving force of a rear wheel in which a relatively large slip has occurred to reduce the slip. At the same time, the control device 10 does not reduce driving force of a rear wheel in which no slip has occurred (or a relatively small slip has occurred).

For example, as illustrated in FIG. 3, when at least one of the left and right rear wheels RW_L and RW_R slips while the motor RM_L (third drive source) and the motor RM_R (fourth drive source) are driving the left rear wheel RW_L and the right rear wheel RW_R (the other set of left and right output units), respectively, the control device 10 reduces the driving force (drive torque) of the motor RM_L that outputs the driving force to the left rear wheel RW_L (Lo_μ wheel) in which a relatively large slip has occurred to reduce the slip. At the same time, the control device 10 does not reduce the driving force (drive torque) of the motor RM_R that outputs the driving force to the right rear wheel RW_R (Hi_μ wheel) in which no slip has occurred.

Therefore, according to the vehicle V equipped with the control device 10, even when a slip has occurred at one of the left and right output units (the left rear wheel RW_L or the right rear wheel RW_R; the left rear wheel RW_L in the example of FIG. 3) that do not steer the vehicle V, and the left and right output units (the left rear wheel RW_L and the right rear wheel RW_R) that do not steer the vehicle V are driven by the motor RM_L (third drive source) and the motor RM_R (fourth drive source), respectively, the driving force of the other output unit (the right rear wheel RW_R or the left rear wheel RW_L; the right rear wheel RW_R in the example of FIG. 3) is not reduced, and thus it is possible to secure the straight traveling stability of the vehicle V while controlling the reduction amount of the total driving force in the vehicle V.

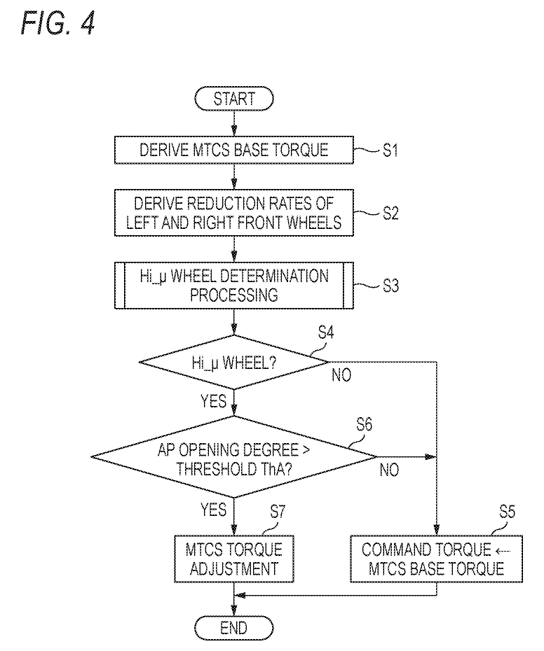

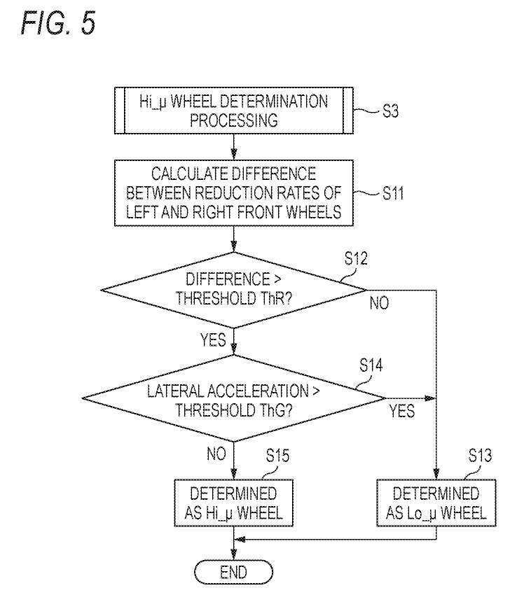

FIG. 4, FIG. 5, and FIG. 7 are flowcharts illustrating an example of a control flow of the dual output unit driving force reduction control performed by the control device 10.

The control illustrated in the flowchart of FIG. 4 is executed, for example, when a slip is detected at the left and right front wheels FW_L and FW_R, which are steering wheels. Specifically, when a slip is detected at at least one of the left front wheel FW_L and the right front wheel FW_R, the control device 10 executes the control illustrated in the flowchart of FIG. 4 for each of the left front wheel FW_L and the right front wheel FW_R.

In the flowchart of FIG. 4, the control device 10 derives an MTCS base torque (FL_MTCS base torque in the case of the processing for the left front wheel FW_L, and FR_MTCS base torque in the case of the processing for the right front wheel FW_R) through the processing of step S1.

Next, the control device 10 derives reduction rates of the left and right front wheels FW_L and FW_R through the processing of step S2. Since the reduction rate has been described above, the description thereof will be omitted here.

Next, the control device 10 performs Hi_μ wheel determination processing through the processing of step S3. In the Hi_μ wheel determination processing, the control device 10 determines whether a wheel targeted in a current routine among the left and right front wheels FW_L and FW_R is a wheel in which no slip has occurred or a relatively small slip has occurred (that is, the Hi_μ wheel). A specific processing procedure of the Hi_μ wheel determination processing is illustrated as a subroutine in the flowchart of FIG. 5.

In the flowchart of FIG. 5, the control device 10 calculates a difference between the reduction rates of the left and right front wheels FW_L and FW_R through the processing of step S11. That is, in the processing of step S11, the difference between the reduction rates of the left and right front wheels FW_L and FW_R derived through the processing of step S2 described above is calculated.

Next, through the processing of step S12, the control device 10 determines whether the difference between the reduction rates calculated in step S11 is greater than a predetermined threshold ThR. The threshold ThR is predetermined as a threshold for determining whether the wheel targeted in the current routine is the Hi_μ wheel or the Lo_μ wheel.

When the difference between the reduction rates calculated in the processing of step S11 is equal to or less than the threshold ThR and thus "NO" is determined in the processing of step S12, the control device 10 proceeds to the processing of step S13 and determines that the wheel targeted in the current routine is the Lo_μ wheel. Thereafter, the control device 10 ends the subroutine illustrated in the flowchart of FIG. 5, and proceeds to the processing of step S4 in the flowchart of FIG. 4 described above.

On the other hand, when the difference between the reduction rates calculated in the processing of step S11 is greater than the threshold ThR and thus "YES" is determined in the processing of step S12, the control device 10 proceeds to the processing of step S14 and determines whether the lateral acceleration of the vehicle V is greater than a predetermined threshold ThG. The threshold ThG is predetermined as a threshold for determining a behavior of the vehicle V particularly during turning travel.

When the lateral acceleration of the vehicle V is greater than the predetermined threshold ThG and thus "YES" is determined in the processing of step S14, the control device 10 proceeds to the processing of step S13 described above.

For example, during the turning travel in which the lateral acceleration of the vehicle V greater than the threshold ThG is generated, active yaw control may be separately activated to limit the driving force of the vehicle V.

Therefore, in the present embodiment, in a case where the lateral acceleration of the vehicle V is greater than the threshold ThG, the control device 10 sets all the wheels to the Lo_μ wheels, and thus does not perform the dual output unit driving force reduction control to reduce the driving force of the Hi_μ wheel to the same value as the driving force of the Lo_μ wheel.

In other words, in the present embodiment, when the lateral acceleration of the vehicle V is less than the threshold ThG (that is, the predetermined value), the control device 10 reduces the driving force of the output unit in which a relatively small slip has occurred or no slip has occurred in the dual output unit driving force reduction control. Accordingly, when the lateral acceleration of the vehicle V is less than the threshold ThG, it is possible to reduce the driving force of the output unit in which a relatively small slip has occurred or no slip has occurred, and thus it is possible to reduce an instance where the driving force of the output unit in which a relatively small slip has occurred or no slip has occurred is reduced while securing the straight traveling stability of the vehicle V.

However, the processing of step S14 is not essential and may be omitted.

On the other hand, when the lateral acceleration of the vehicle V is equal to or less than the predetermined threshold ThG and thus "NO" is determined in the processing of step S14, the control device 10 proceeds to the processing of step S15 and determines that the wheel targeted in the current routine is the Hi_μ wheel. Thereafter, the control device 10 ends the subroutine illustrated in the flowchart of FIG. 5, and proceeds to the processing of step S4 in the flowchart of FIG. 4 described above.

Returning to the flowchart of FIG. 4, the description will be continued. In the processing of step S4 illustrated in FIG. 4, the control device 10 determines whether the wheel targeted in the current routine is the Hi_μ wheel based on the result of the Hi_μ wheel determination processing in step S3. When the target wheel is not the Hi_μ wheel, that is, the target wheel is the Lo_μ wheel and thus "NO" is determined in the processing of step S4, the control device 10 proceeds to the processing of step S5.

In the processing of step S5, the control device 10 controls a motor corresponding to the target wheel using a command torque (in other words, the torque command value) of the motor as an MTCS base torque. Accordingly, as illustrated in FIG. 3 described above, for example, when a slip occurs at the left front wheel FW_L, which is a steering wheel, the control device 10 can control the motor FM_L that outputs the driving force to the left front wheel FW_L (Lo_μ wheel) based on the MTCS base torque (FL_MTCS base torque). In this way, by controlling the motor FM_L using the torque command value as the MTCS base torque, it is possible to reduce the drive torque output by the motor FM_L to reduce the slip occurring at the left front wheel FW_L. When the driving force control for the Lo_μ wheel is performed through the processing of step S5, the control device 10 ends the control flow illustrated in FIG. 4.

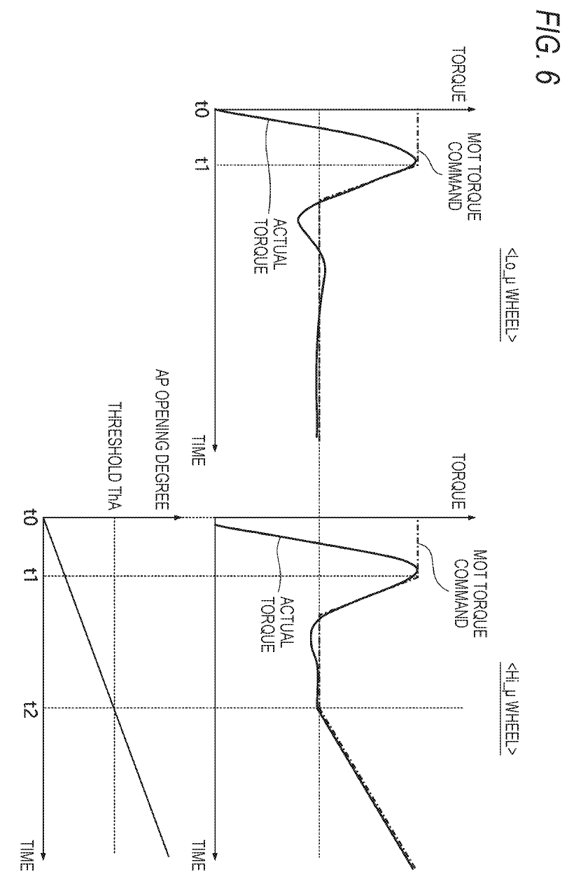

For example, <Lo_μ wheel> in a time chart of FIG. 6 illustrates an example of behaviors of the torque command value (MOT torque command) for the motor FM_L, the drive torque (actual torque) output by the motor FM_L, and the like when the left front wheel FW_L is the Lo_μ wheel and the processing of step S5 is performed.

As illustrated in <Lo_μ wheel> in the time chart of FIG. 6, when detecting that a slip has occurred at the left front wheel FW_L at time t1, the control device 10 gradually decreases the torque command value for the motor FM_L toward the MTCS base torque (FL_MTCS base torque). Accordingly, the actual torque of the motor FM_L is reduced, and the slip occurring at the left front wheel FW_L is reduced.

Returning to the flowchart of FIG. 4, the description will be continued. When the wheel targeted in the current routine is a Hi_μ wheel and thus "YES" is determined in the processing of step S4 illustrated in FIG. 4, the control device 10 proceeds to the processing of step S6.

In the processing of step S6, it is determined whether the accelerator pedal opening (AP opening degree) is greater than a predetermined threshold ThA. The threshold ThA is predetermined as a threshold for determining the extent of an acceleration intention of a driver. For example, when the AP opening degree is greater than the threshold ThA, the control device 10 determines that the driver has an intention to accelerate while knowing that a slip has occurred, and performs the driving force control according to the magnitude of the AP opening degree. Therefore, when the AP opening degree is equal to or less than the threshold ThA and thus "NO" is determined in the processing of step S6, the processing proceeds to step S5, and as before, the command torque (in other words, the torque command value) of the motor corresponding to the target wheel is used as the MTCS base torque to control the motor.

On the other hand, when the AP opening degree is greater than the threshold ThA and thus "YES" is determined in step S6, the control device 10 proceeds to the processing of step S7.

In the processing of step S7, a value obtained by adjusting the MTCS base torque of the wheel targeted in the current routine (hereinafter, also referred to as "adjusted target MTCS torque") is used as the command torque (in other words, the torque command value) of the motor corresponding to the wheel to control the motor.

The adjusted target MTCS torque is, for example, a value obtained by adding or subtracting a predetermined value corresponding to the magnitude of the AP opening degree to or from the MTCS base torque. For example, as illustrated in FIG. 3 described above, when a slip occurs at the left front wheel FW_L that is the steering wheel, the control device 10 controls the motor FM_R that outputs the driving force to the right front wheel FW_R (Hi_μ wheel) facing the left front wheel FW_L in which the slip has occurred based on the adjusted target MTCS torque. By controlling the motor FM_R using the torque command value for the motor FM_R as the adjusted target MTCS torque, the motor FM_R outputs a drive torque corresponding to the magnitude of the AP opening degree. When the driving force control for the Hi_μ wheel is performed through the processing of step S7, the control device 10 ends the control flow illustrated in FIG. 4.

For example, <Hi_μ wheel> in the time chart of FIG. 6 illustrates an example of behaviors of the torque command value (MOT torque command) for the motor FM_R, the drive torque (actual torque) output by the motor FM_R, and the like when the right front wheel FW_R is the Hi_μ wheel and the processing of step S7 is performed.

As illustrated in <Hi_μ wheel> in the time chart of FIG. 6, when detecting that a slip has occurred at the left front wheel FW_L at time t1, the control device 10 also gradually decreases the torque command value (MOT torque command) for the motor FM_R toward the torque command value (FL_MTCS base torque) for the motor FM_L of the left front wheel FW_L in which the slip has occurred. Accordingly, the actual torque of the motor FM_R is also reduced together with the actual torque of the motor FM_L. As a result, the slip occurring at the left front wheel FW_L is reduced, and the driving forces of the left front wheel FW_L and the right front wheel FW_R, which are the steering wheels, are reduced, so that the straight traveling stability of the vehicle V is secured.

Further, in the processing of step S7 described above, the control device 10 controls the motor (for example, the motor FM_R) corresponding to the Hi_μ wheel to output the drive torque corresponding to the magnitude of the AP opening degree.

Therefore, as indicated in <Hi_μ wheel> in the time chart of FIG. 6, when the operation amount of the accelerator pedal (operator), that is, the AP opening degree is greater than the threshold ThA after time t2, the control device 10 reduces the reduction amount of the actual torque of the motor FM_R as compared with the case where the AP opening degree is less than the threshold ThA. That is, the reduction amount of the driving force of the right front wheel FW_R to which the motor FM_R outputs the drive torque is reduced.

As indicated in <Hi_μ wheel> in the time chart of FIG. 6, for example, the control device 10 reduces the reduction amount of the driving force of the right front wheel FW_R in which no slip has occurred as the AP opening degree increases. Therefore, it is possible to secure the straight traveling stability of the vehicle V while controlling the reduction amount of the driving force of the right front wheel FW_R, which is the output unit in which no slip has occurred. In addition, it is possible to appropriately control the reduction amount of the driving force of the right front wheel FW_R, which is the output unit in which no slip has occurred, according to the AP opening degree (operation amount of the operator).

The control illustrated in the flowchart of FIG. 7 is executed, for example, when a slip is detected at the left and right rear wheels RW_L and RW_R, which are non-steering wheels. Specifically, the control device 10 executes the control illustrated in the flowchart of FIG. 7 for a rear wheel in which a slip has occurred between the left and right rear wheels RW_L and RW_R.

In the flowchart of FIG. 7, the control device 10 derives an MTCS base torque through the processing of step S21. For example, when a wheel targeted in the current routine is the left rear wheel RW_L, an MTCS base torque of the left rear wheel RW_L (that is, the motor RM_L) is derived through the processing of step S21. When the wheel targeted in the current routine is the right rear wheel RW_R, an MTCS base torque of the right rear wheel RW_R (that is, the motor RM_R) is derived through the processing of step S21.

Next, through the processing of step S22, the control device 10 controls the motor RM_L or the motor RM_R using a torque command value for a motor corresponding to the wheel targeted in the current routine as the MTCS base torque derived in the processing of step S21. When the driving force control for the Lo_μ wheel is performed through the processing of step S22, the control device 10 ends the control flow illustrated in FIG. 7.

For example, as illustrated in FIG. 3 described above, when a slip occurs at the left rear wheel RW_L that is not a steering wheel, the control device 10 controls the motor RM_L that outputs the driving force to the left rear wheel RW_L (Lo_μ wheel) based on the MTCS base torque. By controlling the motor RM_L using the torque command value as the MTCS base torque, the drive torque output by the motor RM_L is reduced, thereby reducing the slip occurring at the left rear wheel RW_L.

On the other hand, as illustrated in FIG. 3 described above, the control illustrated in the flowchart of FIG. 7 is not performed for the right rear wheel RW_R which is not the steering wheel and in which no slip has occurred. Therefore, for example, when a slip occurs at the left rear wheel RW_L that is not the steering wheel, the control device 10 reduces the driving force (drive torque) of the motor RM_L that outputs the driving force to the left rear wheel RW_L (Lo_μ wheel) in which the slip has occurred to reduce the slip. At the same time, the control device 10 does not reduce the driving force (drive torque) of the motor RM_R that outputs the driving force to the right rear wheel RW_R (Hi_μ wheel) in which no slip has occurred. That is, when a slip occurs at the left rear wheel RW_L that is not the steering wheel, the control device 10 reduces the driving force of the left rear wheel RW_L in which the slip has occurred to reduce the slip. At the same time, the control device 10 does not reduce the driving force of the right rear wheel RW_R in which no slip has occurred.

Therefore, even when a slip has occurred at the left rear wheel RW_L (or the right rear wheel RW_R) that does not steer the vehicle V, the driving force of the right rear wheel RW_R (or the left rear wheel RW_L) in which no slip has occurred is not reduced, and thus it is possible to secure the straight traveling stability of the vehicle V while controlling the reduction amount of the total driving force in the vehicle V.

Although the embodiment of the present disclosure has been described, it goes without saying that the present disclosure is not limited to such an example. It is apparent that those skilled in the art can conceive of various modifications and alterations within the scope described in the claims, and it is understood that such modifications and alterations naturally fall within the technical scope of the present disclosure.

For example, in the above-described embodiment, the example in which the vehicle V in the present disclosure is a battery electric vehicle using an electric motor as a drive source has been described, but the present disclosure is not limited thereto. For example, the vehicle V in the present disclosure may be a hybrid electrical vehicle equipped with an internal combustion engine together with an electric motor as a drive source.

In addition, the constituent elements in the embodiment described above may be freely combined without departing from the gist of the disclosure.

In the present description and the like, at least the following matters are described. Although corresponding constituent elements or the like in the above embodiment are illustrated in parentheses, the present disclosure is not limited thereto.

1 A moving object (vehicle V) including:

a first drive source (motor FM_L) configured to output braking force and driving force to one of a left outputter and a right outputter (left front wheel FW_L);

a second drive source (motor FM_R) configured to output braking force and driving force to the other of the left outputter and the right outputter (right front wheel FW_R); and

a control device (10) configured to control the first drive source and the second drive source, in which

the control device is configured to, in response to a slip occurring at at least one of the left outputter and the right outputter while the first drive source and the second drive source drive the right outputter and the left outputter, perform dual outputter driving force reduction control such that

driving force to be outputted by one of the first drive source and the second drive source that outputs the driving force to an outputter at which a relatively large slip has occurred is reduced to reduce the slip, and

driving force to be outputted by the other of the first drive source and the second drive source that outputs the driving force to an outputter at which a relatively small slip has occurred or no slip has occurred is reduced to the same value as the driving force of the outputter at which the relatively large slip has occurred.

According to (1), when a slip (for example, a slip caused by acceleration) occurs in at least one of the left and right output units, the driving force of the output unit in which a slip has occurred is reduced to reduce the slip, and the driving force of the other output unit is reduced to the same value as the driving force of the output unit in which a slip has occurred, so that it is possible to prevent the generation of the yaw moment in the moving object. Accordingly, even when the moving object does not include a differential device (so-called differential gear), it is possible to prevent a yaw behavior of the moving object when a slip occurs in at least one of the left and right output units, and secure the straight traveling stability of the moving object.

2 The moving object according to (1), in which

the control device is configured to perform the dual outputter driving force reduction control when a reduction amount of the driving force of the outputter at which the relatively large slip has occurred is equal to or greater than a predetermined value.

According to (2), when the reduction amount of the driving force of the output unit in which a relatively large slip has occurred is equal to or greater than the predetermined value, it is possible to reduce the driving force of the output unit in which a relatively small slip has occurred or no slip has occurred, and thus it is possible to reduce an instance where the driving force of the output unit in which a relatively small slip has occurred or no slip has occurred is reduced while securing the straight traveling stability of the moving object.

3 The moving object according to (2), further including a lateral acceleration acquirer (lateral acceleration sensor Se4) configured to acquire lateral acceleration of the moving object, in which

the control device is configured to, in response to the lateral acceleration being less than a predetermined value, reduce the driving force of the outputter at which the relatively small slip has occurred or no slip has occurred in the dual outputter driving force reduction control.

According to (3), when the lateral acceleration is less than the predetermined value, it is possible to reduce the driving force of the output unit in which a relatively small slip has occurred or no slip has occurred, and thus it is possible to reduce an instance where the driving force of the output unit in which a relatively small slip has occurred or no slip has occurred is reduced while securing the straight traveling stability of the moving object.

4 The moving object according to (1), further including an operator (AP sensor Se3) configured to acquire a braking request and a drive request for the moving object, in which

the control device is configured to perform the dual outputter driving force reduction control when an operation amount of the operator is less than a predetermined value.

According to (4), when the operation amount of the operator that acquires the braking request and the drive request is less than the predetermined value, it is possible to reduce the driving force of the output unit in which a relatively small slip has occurred or no slip has occurred, and thus it is possible to reduce an instance where the driving force of the output unit in which a relatively small slip has occurred or no slip has occurred is reduced while securing the straight traveling stability of the moving object.

5 The moving object according to (4), in which

the control device is configured to, in response to the operation amount of the operator being equal to or greater than the predetermined value, reduce a reduction amount of the driving force of the outputter at which the relatively small slip has occurred or no slip has occurred as compared with a case where the operation amount of the operator is less than the predetermined value.

According to (5), when the operation amount of the operator is equal to or greater than the predetermined value, the reduction amount of the driving force of the output unit in which a relatively small slip has occurred or no slip has occurred is made smaller than that when the operation amount is less than the predetermined value, so that it is possible to secure the straight traveling stability of the moving object while controlling the reduction amount of the driving force of the output unit in which a relatively small slip has occurred or no slip has occurred.

6 The moving object according to (5), in which

the control device is configured to, in response to the operation amount of the operator being equal to or greater than the predetermined value, reduce the reduction amount of the driving force of the outputter at which the relatively small slip has occurred or no slip has occurred as the operation amount of the operator increases.

According to (6), when the operation amount of the operator is equal to or greater than the predetermined value, the reduction amount of the driving force of the output unit in which a relatively small slip has occurred is reduced as the operation amount increases, so that the reduction amount of the driving force of the output unit in which a relatively small slip has occurred can be appropriately controlled according to the operation amount of the operator.

7 The moving object according to (1), in which

the left outputter (left front wheel FW_L) and the right outputter (right front wheel FW_R) are outputters that steer the moving object,

the moving object includes another left outputter and another right outputter that do not steer the moving object, and a drive source (motors RM_L and RM_R) configured to output braking force and driving force to the another left outputter and the another right outputter, and

when a slip occurs at at least one of the another left outputter and the another right outputter while the drive source drive the another left outputter and the another right outputter, the control device is configured to reduce the driving force of one of the another left outputter and the another right outputter at which a relatively large slip has occurred to reduce the slip, and the control device is configured not to reduce driving force of the other of the another left outputter and the another right outputter at which a relatively small slip has occurred or no slip has occurred.

According to (7), even when a slip occurs in one of the left and right output units that do not steer the moving object, the driving force of the other output unit is not reduced, and thus it is possible to secure the straight traveling stability of the moving object while controlling a reduction amount of a total driving force in the moving object.

8 The moving object according to (7), in which

the drive source configured to output the braking force and the driving force to the another left outputter and the another right outputter includes

a third drive source (motor RM_L) configured to output braking force and driving force to one of the another left outputter and the another right outputter, and

a fourth drive source (motor RM_R) configured to output braking force and driving force to the other of the another left outputter and the another right outputter, and

when a slip occurs at at least one of the another left outputter and the another right outputter while the third drive source and the fourth drive source drive the another left outputter and the another right outputter, the control device is configured to reduce the driving force of one of the another left outputter and the another right outputter at which the relatively large slip has occurred to reduce the slip, and not to reduce the driving force of the other of the another left outputter and the another right outputter at which the relatively small slip has occurred or no slip has occurred.

According to (8), even in the configuration in which the left and right output units that do not steer the moving object are driven by the third drive source and the fourth drive source, respectively, it is possible to secure the straight traveling stability of the moving object while controlling the reduction amount of the total driving force in the moving object.

What is claimed is:

1. A moving object comprising:
a first drive source configured to output braking force and driving force to one of a left outputter and a right outputter;
a second drive source configured to output braking force and driving force to the other of the left outputter and the right outputter; and
a control device configured to control the first drive source and the second drive source, wherein
the control device is configured to, in response to a slip occurring at at least one of the left outputter and the right outputter while the first drive source and the second drive source drive the right outputter and the left outputter, perform dual outputter driving force reduction control such that
driving force to be outputted by one of the first drive source and the second drive source that outputs the driving force to an outputter at which a relatively large slip has occurred is reduced to reduce the slip, and
driving force to be outputted by the other of the first drive source and the second drive source that outputs the driving force to an outputter at which a relatively small slip has occurred or no slip has occurred is reduced to the same value as the driving force of the outputter at which the relatively large slip has occurred.

2. The moving object according to claim 1, wherein
the control device is configured to perform the dual outputter driving force reduction control when a reduction amount of the driving force of the outputter at which the relatively large slip has occurred is equal to or greater than a predetermined value.

3. The moving object according to claim 2, further comprising a lateral acceleration acquirer configured to acquire lateral acceleration of the moving object, wherein
the control device is configured to, in response to the lateral acceleration being less than a predetermined value, reduce the driving force of the outputter at which the relatively small slip has occurred or no slip has occurred in the dual outputter driving force reduction control.

4. The moving object according to claim 1, further comprising an operator configured to acquire a braking request and a drive request for the moving object, wherein
the control device is configured to perform the dual outputter driving force reduction control when an operation amount of the operator is less than a predetermined value.

5. The moving object according to claim 4, wherein
the control device is configured to, in response to the operation amount of the operator being equal to or greater than the predetermined value, reduce a reduction amount of the driving force of the outputter at which the relatively small slip has occurred or no slip has occurred as compared with a case where the operation amount of the operator is less than the predetermined value.

6. The moving object according to claim 5, wherein
the control device is configured to, in response to the operation amount of the operator being equal to or greater than the predetermined value, reduce the reduction amount of the driving force of the outputter at which the relatively small slip has occurred or no slip has occurred as the operation amount of the operator increases.

7. The moving object according to claim 1, wherein
the left outputter and the right outputter are outputters that steer the moving object,
the moving object comprises another left outputter and another right outputter that do not steer the moving object, and a drive source configured to output braking force and driving force to the another left outputter and the another right outputter, and
when a slip occurs at at least one of the another left outputter and the another right outputter while the drive source drive the another left outputter and the another right outputter, the control device is configured to reduce the driving force of one of the another left outputter and the another right outputter at which a relatively large slip has occurred to reduce the slip, and the control device is configured not to reduce driving force of the other of the another left outputter and the another right outputter at which a relatively small slip has occurred or no slip has occurred.

8. The moving object according to claim 7, wherein
the drive source configured to output the braking force and the driving force to the another left outputter and the another right outputter includes
a third drive source configured to output braking force and driving force to one of the another left outputter and the another right outputter, and
a fourth drive source configured to output braking force and driving force to the other of the another left outputter and the another right outputter, and
when a slip occurs at at least one of the another left outputter and the another right outputter while the third drive source and the fourth drive source drive the another left outputter and the another right outputter, the control device is configured to reduce the driving force of one of the another left outputter and the another right outputter at which the relatively large slip has occurred to reduce the slip, and not to reduce the driving force of the other of the another left outputter and the another right outputter at which the relatively small slip has occurred or no slip has occurred.
